(19) United States
(12) Patent Application Publication
(10) Pub. No.: US 2023/0384595 A1
(43) Pub. Date: Nov. 30, 2023

(54) CURVED LIGHTGUIDE AND APPARATUS AND METHODS EMPLOYING A CURVED LIGHTGUIDE

(71) Applicant: University of Rochester, Rochester, NY (US)

(72) Inventors: Nicholas S. Kochan, Rochester, NY (US); Tianyi Yang, Rochester, NY (US); Greg R. Schmidt, Rochester, NY (US)

(73) Assignee: University of Rochester, Rochester, NY (US)

(21) Appl. No.: 18/030,837

(22) PCT Filed: Oct. 14, 2021
(86) PCT No.: PCT/US2021/054904

§ 371 Date: Apr. 7, 2023

Related U.S. Application Data
(60) Provisional application No. 63/091,539, filed on Oct. 14, 2020.

(51) Int. Cl. G02B 27/01

(52) U.S. Cl. CPC G02B 27/0172; G02B 2027/0123

(57) ABSTRACT

A lightguide comprised of a transmission medium having a first curved outer surface and a second curved outer surface and in at least one cross-section of the lightguide. The first curved outer surface and the second curved outer surface are substantially concentric around a point. The transmission medium having a gradient index of refraction that decreases as function of increasing distance from the point, the gradient index extending from the first curved surface to the second curved surface. At least one light extraction element disposed to extract light from the transmission medium and direct the light generally toward the point. Both the lightguide and the gradient index profiles may be spherical or cylindrical.

### FIELD

Curved lightguide and methods and apparatus for display of augmented reality (AR) and virtual reality (VR) image content, in particular curved lightguide and methods and apparatus for display of AR and VR image content using a curved lightguide.

### BACKGROUND

Augmented reality and virtual reality display systems (referred to herein collectively as AR/VR display systems) present images to a viewer to allow for an interactive experience with a computer-generated environment. Frequently, such systems come in the form of eyewear (e.g., goggles), but may have other configurations.

A light source provides image content for the display system, which is relayed to the viewer. Lightguide technologies are commonly used to relay the images from the source to a viewer, to allow for compactness of the display system. Lightguides are comprised of a transmission medium (e.g., glass or plastic) and typically have outer surfaces that are planar. The outer surfaces provide total internal reflection to guide light within the lightguide.

Conventional lightguide-based AR/VR display systems typically use diffraction or reflection techniques to extract light from a lightguide and project the light to the eyes of a viewer. Diffraction techniques use extraction features smaller than or approximately equal to the operative wavelength(s) of light to redirect (i.e., diffract) light of selected wavelengths toward an eye and render images for viewing by a viewer. By contrast, reflection techniques use reflective extraction features to redirect (i.e., geometrically reflect) light toward an eye to render images for viewing by a viewer. Two choices for reflection-based extraction are partially-reflective mirror systems, which use facets embedded in the lightguide to extract light, and micromirror arrays, which use an array of small switchable mirrors (e.g., a switchable Bragg grating or a MEMS mirror device) to extract light from a lightguide. Regardless of the extraction technology, a lightguide is required to guide light in a manner that, in conjunction with the extraction elements (e.g., diffraction grating or reflector), projects light to a viewer in a manner that conserves ray angles of images from the source well enough to allow images to be perceived by the viewer.

Typical display goggles cover an area comparable to that of conventional wrap-around eyewear. For user comfort, a light source is preferably small and injects light into the goggles over a small surface area. The light source typically provides preprocessed image information (e.g., images having a non-rectangular array format or images that have been otherwise provided with compensation for projections through a display system). The display system transmits the light through a lightguide, then extraction features direct image information to the viewer's eyes.

For AR applications, in addition to guiding light, the lightguide may serve as a see-through window for the viewer to observe the real world. Accordingly, edge-injection of light from the source into the lightguide is often the preferred option, so that the illumination optics do not obscure the viewer's field of view of the real world. Many display systems are designed for use with a planar lightguide and rely on a planar lightguide's ability to conserve the angles of the injected light after the light is directed through the light guide using total internal reflection. FIG. 1 is a schematic cross-sectional side view of a planar lightguide 10 showing that parallel rays R₁ and R₂ projected into a planar lightguide at an arbitrary angle θ remain parallel after one or more reflections by an outer surface of the lightguide. Despite the benefit of the conserving the angles, planar lightguides have limitations.

FIG. 2 is a schematic side view of a planar lightguide 12 illustrating limitations of using a planar lightguide in an AR/VR display system. Firstly, since eyes are spherical and rotate about the center of an eye CE (e.g., between positions A and B), when using a planar lightguide to view a relatively large field of view, the distance from the pupil of the eye to the lightguide must change as the eye rotates to view various locations within the field of view (e.g., locations C and D).

Secondly, planar lightguides providing large fields of view are difficult to design and implement because, as the size of a planar lightguide increases, rays are required to exit the surface of the lightguide at larger angles. For example, light at location D at an off-axis location requires, both, that rays impinge on the lightguide and that rays exit the lightguide at larger angles (as measured relative a normal of a surface 13 of lightguide 10) than light at point C in the center of the field of view. As a result, in display systems using reflection technology to extract light from the lightguide, the variation in the angle of exit from the planar lightguide requires the design of irregularly shaped extraction elements or that a variety of optimized display extraction elements be used in the same display. Similarly, for display systems using diffraction gratings, the design of the diffraction grating needs to vary along the lightguide to cover a wide field of view to avoid variations in the quality of the image presented to a viewer across the field of view. Accordingly, increasing the field of view of a planar light guide results in added complexity of, both, design and manufacture of display systems.

Further, even if the above complications of increasing field of view of a planar lightguide are overcome, the mismatch of the planar geometry of the lightguide and the spherical geometry associated with the rotation of an eye means that the size of a display apparatus using a planar lightguide becomes prohibitive as field of view increases, and in the extreme would need to be infinitely long to achieve a field of view of 180 degrees.

### SUMMARY

Curved lightguides offer the ability to reduce the range of emission angles of light exiting the lightguide and allows an eye to maintain a fixed distance from the pupil of the eye to the lightguide as the eye rotates; however, curved lightguides have drawbacks.

Aspects of the present invention are directed to curved lightguides for use in AR/VR display systems which better conserve ray angle and allow for a wider field of view.

According to aspects of the present invention, conservation of ray angles for light relayed by a curved lightguide is achieved using an index of refraction that decreases as radial distance from a center of curvature of the lightguide increases. Typically, the gradient index of refraction (also referred to herein as a gradient index) is monotonically decreasing between the first curved surface and the second curved surface. For example, the gradient index profile may be chosen to be a spherically symmetric gradient index (also referred to herein as a spherical gradient index) or a cylindrically symmetric gradient index (also referred to herein as a cylindrical gradient index).

An aspect of the invention is directed to an optical apparatus for guiding and projecting light, comprising a lightguide comprised of a transmission medium having a first curved outer surface and a second curved outer surface and in at least one cross-section of the lightguide. The first curved outer surface and the second curved outer surface are substantially concentric around a point. The transmission medium has a gradient index of refraction that decreases as function of increasing distance from the point, the gradient index extending the entire distance from the first curved surface to the second curved surface. At least one light extraction element is disposed to extract light from the transmission medium and direct the light generally toward the point.

The apparatus may further comprise a light source to project light into the lightguide. The light source may be configured and arranged to project light into an edge of the lightguide. In some embodiments, the light source is adapted to emit light within a visible band. The light source may be adapted to emit light at one or more discrete wavelengths within the visible band.

In some embodiments, the gradient index of refraction decreases monotonically as function of increasing distance from the point.

In some embodiments, the first curved outer surface and the second curved outer surface are spherical surfaces substantially concentric around the point, and the gradient index of refraction is a spherical gradient index having a center point at the point. In some embodiments, the gradient index is present at substantially all locations between the first curved surface and the second curved surface; however, the gradient index may be limited to locations within the lightguide that light traverses between the source and the at least one extraction element.

In some embodiments, the first curved outer surface and the second curved outer surface are cylindrical surfaces substantially concentric around a center line, and the gradient index of refraction is a cylindrical gradient index symmetric around the center line, and wherein the point is located on the center line. In some embodiments, the gradient index is present at substantially all locations between the first curved surface and the second curved surface; however, the gradient index may be limited to locations within the lightguide that light traverses between the source and the at least one extraction element.

Another aspect of the invention is directed to a curved lightguide, comprising a transmission medium having a first curved outer surface and a second curved outer surface. In at least one cross-section of the lightguide, the first curved outer surface and the second curved outer surface substantially concentric around a point, the transmission medium having a gradient index of refraction that decreases as function of increasing distance from the point. The gradient index extending from the first curved surface to the second curved surface.

In some embodiments, the first curved outer surface and the second curved outer surface are spherical surfaces substantially concentric around the point, and the gradient index of refraction is a spherical gradient index having a center point at the point.

In some embodiments, the first curved outer surface and the second curved outer surface are cylindrical surfaces substantially concentric around a center line, and the gradient index of refraction is a cylindrical gradient index symmetric around the center line, and wherein the point is located on the center line.

As used herein the term “spherical gradient index” refers to an index of refraction that varies substantially as a function of α/r (where α is a constant) as measured in a spherical coordinate system from a single center point of the gradient index.

A lightguide that has the same index at all locations that are a same radial distance from the single center of curvature is referred to herein as having an index of refraction that is spherically symmetric.

As used herein the term “cylindrical gradient index” refers to an index of refraction that varies substantially as a function of α/r (where α is a constant) as measured in a circular coordinate system from one of a plurality of center points that extend down a line of symmetry.

A lightguide that has the same index at all locations that are a same radial distance that is perpendicular to a same line of symmetry is referred to herein as having an index of refraction that is cylindrically symmetric.

These and other aspects of the present invention will become apparent upon a review of the following detailed description and the claims appended thereto

### BRIEF DESCRIPTION OF THE DRAWINGS

FIG. 1 is a prior art schematic, cross-sectional side view of a planar lightguide illustrating a simplified scenario including only rays corresponding to a collimated light input of a single angle 0;

FIG. 2 is a prior art schematic side view of a planar lightguide illustrating limitations of using a planar lightguide in an AR/VR display system;

FIG. 3 is a schematic illustration of a curved lightguide having spherically-shaped outer surfaces that are concentric about a center of curvature and a homogeneous (i.e., uniform) index of refraction;

FIG. 4 is a schematic, cross-sectional side view illustration of a curved lightguide having a spherical gradient index according to aspects of the present invention and showing only rays corresponding to a collimated light input at a zero input angle;

FIG. 5 is a schematic illustration two parallel rays having a non-zero input angle propagating in a lightguide having a spherical gradient index according to aspects of the present invention;

FIG. 6 is a plot of index of refraction as a function of radial position, illustrating one example of a spherical gradient index suitable for use as a lightguide of a display system according to aspects of the present invention;

FIG. 7A is a plan view of an example of a spherical shell lightguide have a spherical gradient index for use in a display system according to aspects of the present invention;

FIG. 7B is a cross-sectional side view of the lens of FIG. 7A taken along line 7B-7B;

FIG. 7C is a cross-sectional side view of the lens of FIG. 7A taken along line 7C-7C;

FIG. 8 is a schematic perspective view of a display system using a spherical shell, spherical gradient index lightguide according to aspects of the invention;

FIG. 9 is a schematic illustration of the performance of the display system of FIG. 8 along a single plane including the origin of the sphere and a light input location I;

FIG. 10A is a plan view of an example of a cylindrical shell light guide having a cylindrical gradient index according to aspects of the present invention;

FIG. 10B is a cross-sectional side view of the lens of FIG. 10A taken along line 10B-10B; and

FIG. 10C is a cross-sectional side view of the lens of FIG. 10A taken along line 10C-10C.

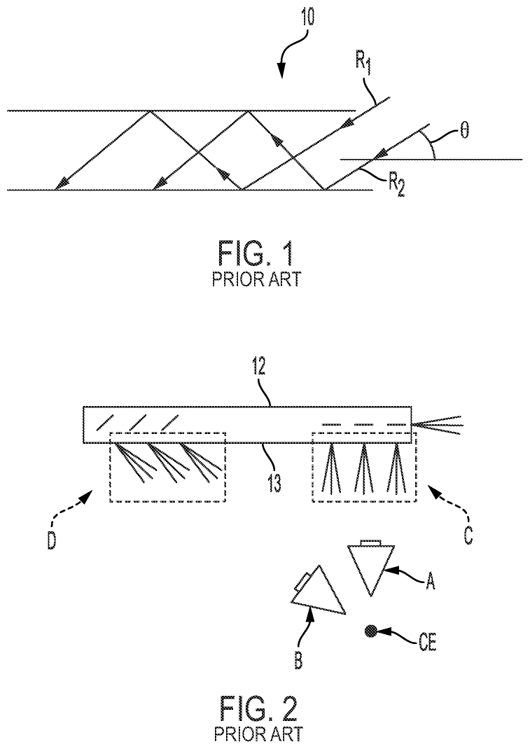

### DETAILED DESCRIPTION

Aspects of the invention will be further illustrated with reference to the following specific examples. It is understood that these examples are given by way of illustration and are not meant to limit the claims to any specific embodiment.

Aspects of the present invention are directed to a lightguide comprised of a transmission medium (e.g., glass or plastic) and having outer surfaces that are curved and provide total internal reflection to guide light within the lightguide. The transmission medium has a gradient-index profile which conserves ray angle better in at least one dimension of light transmission than a curved lightguide having a same shape and a homogeneous (i.e., uniform) index of refraction throughout a lightguide. To achieve such improved conservation of ray angle, the index of refraction decreases as radial distance from a location of symmetry of the surfaces of the lightguide increases. In some embodiments, the lightguide has an index that is spherically symmetric about a center point (also referred to herein as centers of curvature) and in other embodiments the lightguide has an index that is cylindrically symmetric about a line comprising a plurality of center points. Regardless of whether the lightguide is spherical or cylindrical, in both spherical and cylindrical embodiments, the outer surfaces of the lightguide are concentric about the center of curvature in at least one cross-section including a center point. For example, the gradient of index may have a spherical gradient index or a cylindrical gradient index.

Curved lightguides having spherically-shaped outer surfaces that are concentric about a center of curvature (also referred to herein as a spherical shell lightguide) represent a possible solution to providing a wide field of view; however, as shown in FIG. 3, collimated rays of light input from a source 10 propagate within a spherical lightguide 50 having a center of curvature CO and having a homogeneous index of refraction in a nonuniform and geometrically complex manner as compared to a planar homogeneous lightguide.

Due to the complexities of light transmission in curved lightguides, non-sequential raytracing is required, and design of light sources and image content for use with curved lightguides is also complex, resulting in unviewable images exiting a display system or prohibitively difficult preprocessing of images for a projection by a source. Furthermore, the performance of the resulting designs tends to be sensitive to variations in manufacture.

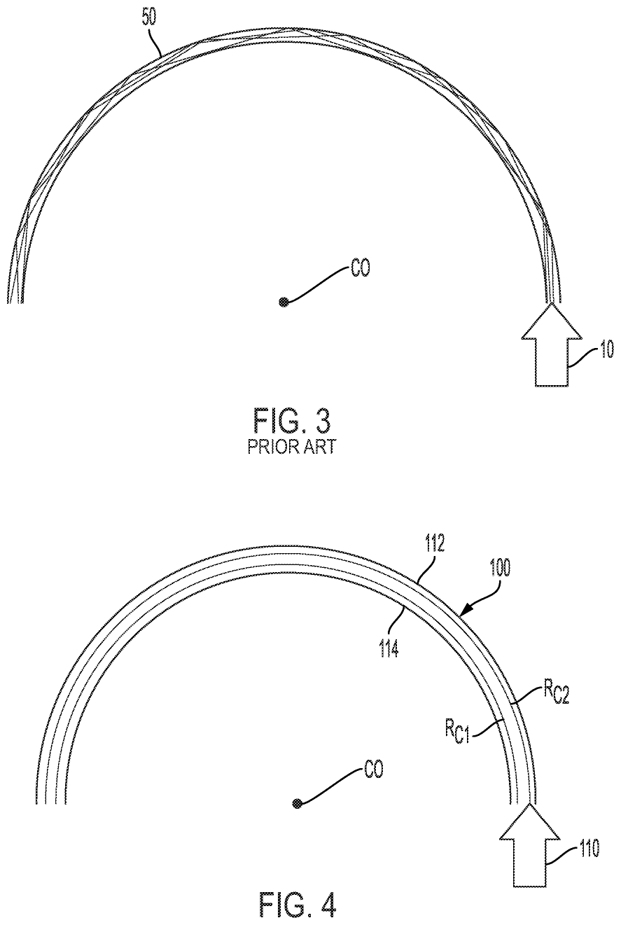

FIG. 4 is a schematic side view of a curved lightguide 100 having a spherical shell configuration and having spherical gradient index of refraction suitable for use in an AR/VR display system characterized by an ability to conserve ray angles (i.e., each ray maintains a fixed angle with respect to all spherical surfaces concentric with the lightguide spherical surfaces, including the exit surface of a spherical lightguide) as the light is propagated through the lightguide. In lightguide 100, the center of curvature CO of the outer surfaces 112 and 114 is coincident with the center point of the spherical gradient index such that outer surfaces are parallel to (i.e., concentric with) lines of uniform index of refraction.

As shown in FIG. 4, the ray angles of collimated rays R_{C1} and R_{C2} projected into a lightguide having a spherical gradient index, by a light source 110 at zero input angle (i.e., parallel to the lines of uniform index of refraction) are maintained as the light is transmitted through the lightguide. Accordingly, the spherical gradient index causes the spherical lightguide to behave like a planar homogeneous lightguide where collimated rays that are input parallel to the lines of uniform index of refraction remain equidistant from one another thus conserving their ray angles.

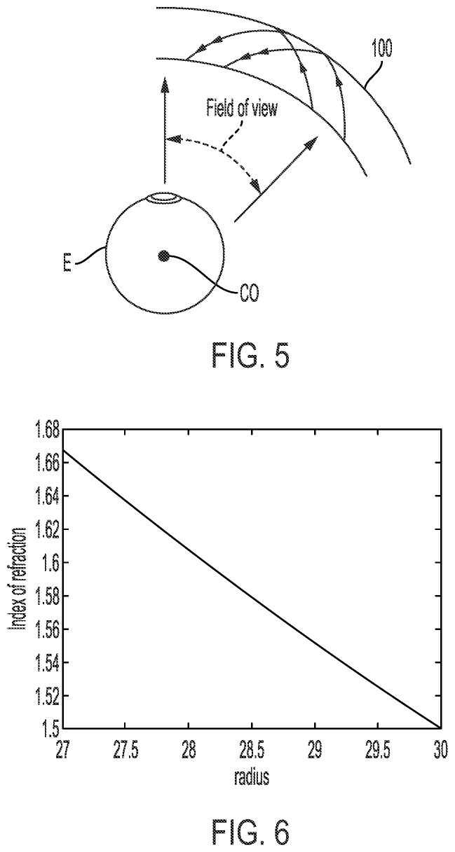

Although light source 110 in FIG. 4 is illustrated as providing only collimated light at zero input angle for ease of description, it will be appreciated that a light source will typically, also, provide collimated rays having a non-zero input angle (i.e., not parallel to outer surfaces of lightguide) and that the rays having a non-zero input angle will also propagate within the lightguide with the angles of the rays being conserved. FIG. 5 is a schematic illustration two parallel rays having a non-zero input angle propagating in a light guide 100 having a spherical gradient index. The light guide is shown relative to an eye E having a field of view. The illustrated rays are assumed to have been input into the lightguide at a common input angle relative to the lines of uniform index of refraction in the spherical gradient index of refraction (i.e., as measured after refraction into the lightguide), and (as shown) propagate in the lightguide at a common angle relative to the lines of uniform index of refraction. As illustrated, although the rays curve as they are transmitted through the lightguide, the relative spacing between rays of same input angle is maintained at each radial distance from CO throughout propagation thus conserving ray angles, including upon reflection from a lightguide surface.

Proof that a curved lightguide having a α/r spherical gradient index (GRIN) profile conserves ray angles similar to a planar lightguide is set forth below.

As is known in the art, a quantity β (see Equation 1, below) is conserved for rays in any spherically symmetric GRIN optic.

β=nr sin ψ Equation 1
where n=n(r) is the refractive index at a selected point, where r is the radial distance of the selected point away from the center point of the spherical GRIN, and ψ is the angle the ray forms with the radial spoke extending through the center point and the selected point.

To achieve the goal of conserving ray angles, the present embodiment conserves ψ. A 1/r spherical gradient index is represented by Equation 2, where it is assumed that the GRIN construction is chosen so that the surfaces of equal index are concentric with the curved outer surfaces of the lightguide.

$$n = \frac{α}{r} \qquad Equation 2$$

where α is a constant defining a change in index with respect to r.

Combining equations 1 and 2 and converting the result to the differential form, the following equation results.

$$cot ψ d θ = \frac{dr}{r} \qquad Equation 3$$

where θ is an angular coordinate including the plane through the origin i.e., r=0

After integration of both sides, and introduction of a constant of integration C Equation 4 results.

(cot ψ)θ=log r+C Equation 4

When constant C is chosen as −log r₀+(cot ψ)θ₀, Equation 4 can be rewritten as follows.

(cot ψ)θ=log r−log r₀+(cot ψ)θ₀ Equation 5

Equation 5 can be rewritten as follows:

r=r₀e^{(cot ψ)(θ-θ}^{₀}⁾ Equation 6

It will be appreciated that Equation 6 is a logarithmic spiral, a function known to be associated with conservation of ray angle. Thus, if surfaces performing total internal reflection are concentric with the GRIN and all rays originate with ψ greater than the critical angle, then the angle of incidence for each ray will change sign from positive to negative upon each reflection from an outer surface of a lightguide but will maintain the magnitude of the angle of reflection with each outer surface, thus conserving the ray angles.

FIG. 6 is a plot of index of refraction as a function of radial position, illustrating one example of a 1/r spherical gradient index suitable for use in a lightguide of a display system according to aspects of the present invention. In this example the gradient index is spherically symmetric about a center point, with index of refraction decreasing as a function of the radial distance measured relative to the center point. The radial distance as shown in FIG. 6 may be specified in millimeters (mm) or any other suitable unit of length. Practical limits on the values of index of refraction are based on the materials constituting the gradient index lightguide, and the distance from the center point being far enough from the inner surface of the lightguide to permit viewing of the light output from the lightguide by a viewer having a center of an eye located at the center point.

For example, a lightguide having a spherical gradient index can be formed using conventional three-dimensional printing techniques to deposit layers of a suitably-doped thermoformable polymer to achieve the spherical variation of index. Alternatively, layers may be formed by combining amounts of a relatively low index material and relatively high index material, where successive layers include differing amounts of the relatively low index material and the relatively high index material to achieve the desired index of refraction of a given layer. The materials may be subsequently diffused together using known techniques. For example, an acrylic may be used as the low index material and the high index material can be one or more of polyurethane, butyl methacrylate, styrene and benzyl methacrylate. Alternatively, doping of a glass or plastic lightguide may be used to form a spherical gradient index where the doping can be achieved using sodium or potassium ion exchange in a conventional manner. Yet another alternative is generating an axially symmetric gradient index material (i.e., a flat gradient index material, where the gradient index varies a function of linear dimension) and subsequently thermoforming the material to a spherical shape.

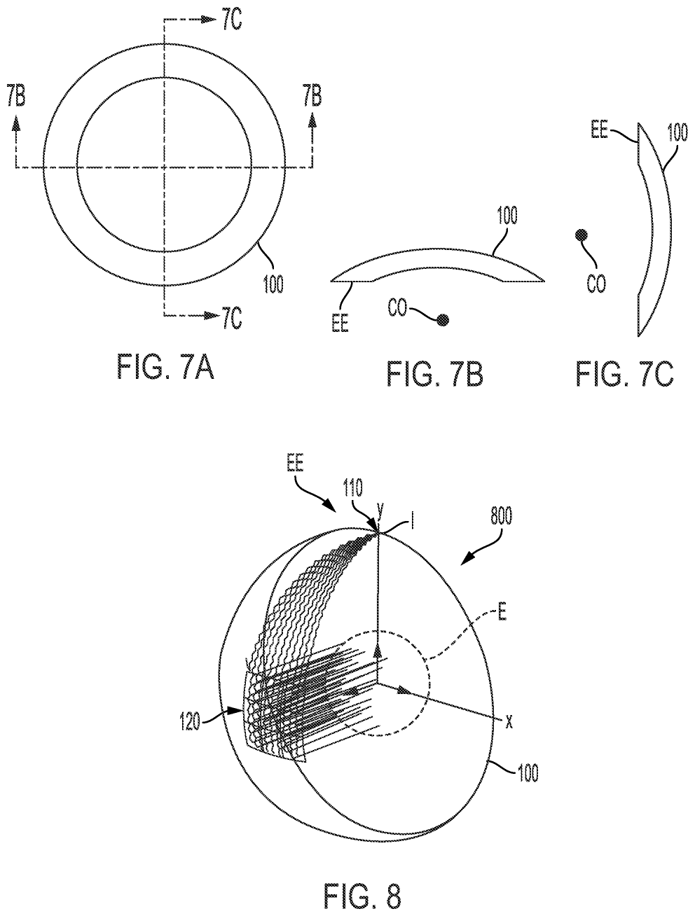

FIGS. 7A-7C are schematic illustrations of an example of a spherical shell lightguide 100 having a spherical gradient index for use in a display system according to aspects of the present invention. In the illustrated example, the lightguide has an index that is spherically symmetric about a center point CO and the outer surfaces of the light guide are concentric about point CO; however, only a portion of a sphere (i.e., a spherical shell) is used to form the lightguide. The spherical shell terminates in an edge EE. As a result of the properties set forth above, a spherical shell lightguide can perform the same lightguiding function as the planar lightguide (i.e., preserving the angle of the ray throughout its path in spherical coordinates) while addressing drawbacks of planar lightguides and spherical lightguides. For example, making the lightguide concentric with the eye results in less variation in reflection angle or diffraction angle at each of one or more extraction elements (shown in FIG. 8).

Further, the spherical nature of the construction will allow an eye to maintain a substantially fixed distance from the pupil of the eye to the lightguide throughout the entire field of view. It will be appreciated that a display for augmented reality is typically designed for the foveated field of view at a given fixated gaze of the eye. The foveated region moves symmetrically around the center of the eye, and with respect to a concentric or near-concentric spherical augmented reality display.

Additionally, a large field of view can be provided without large ray angles exiting the lightguide to the eye, unlike in the planar system. The shape of a curved lightguide allows for reduced exit angles (as measured relative the surface normal), typically resulting in improved diffraction efficiency.

Similar to a planar lightguide, a curved lightguide having a spherical GRIN lens conserves ray angles throughout the guide, but in a curved geometry. This ability enables expansion of the field of view of the display, and the use of features that are designed for use with planar lightguides (e.g. a light source designed for use with a planar lightguide or an extraction element designed for use with a planar lightguide).

In some embodiments, the outer surfaces of the curved lightguide according to aspects of the present invention may not be precisely concentric with one another or with the GRIN. For example, a lightguide for use in AR may have one or more of the outer surfaces designed to perform aberration correction of light transmitted from the real world, while maintaining ray angles of light propagated through the lightguide well enough to allow images to be perceived by a viewer.

FIG. 8 is a schematic perspective view of a display system 800 using a spherical shell, spherical gradient index lightguide 100 according to aspects of the invention. Light is injected into the lightguide by a light source 110 and repeatedly reflects off the outer surfaces of the lightguide as the light propagates through the lightguide. In the illustrated embodiment, the light source is positioned to inject light into an edge of the lightguide and the light radiates through the GRIN as illustrated. In FIG. 8, light is emitted from a point source at location I. The light is input at various input angles relative to the gradient index and after multiple reflections from the lightguide surface is extracted by extraction element 120 to form a collimated or nearly collimated light output. Although a single point source is illustrated for ease of viewing, a light source may comprise multiple points for form a complete image, each source resulting in a corresponding collimated or nearly collimated light output. Although the light source is illustrated relatively near the lightguide to provide a finite conjugate light input, a light source may alternatively be distant from the lightguide to provide a substantially infinite conjugate (i.e., collimated) light input.

Extraction element 120 (e.g., a diffraction grating or a reflective element) may be used to emit collimated light to eye E. Due to the angle conservation provided by lightguides according to aspects of the present invention, extraction elements suitable for use with planar lightguides are also suitable for use with curved light guides according to aspects of the present invention thus simplify the design of display system such that the angles of the rays are maintained with respect to extraction elements and allowing for some deviation due to, for example, aberration correction and eye focal characteristics. In some instances, to optimize an extraction element for use with a spherical shell lightguide, it may be desirable to map a planar extraction element into a curved shape using conventional techniques. For example, LightTools illumination design software or RSoft photonic device design tool (both available from Synopsys, Inc. of Mountain View, CA) may be used to optimize a design, although other software capable of nonsequential ray tracing may be used. The angle of the rays through the GRIN are conserved by lightguide 100 so that rays associated with a given input angle from source 110 impinge on an extraction element 120 (e.g., diffraction grating or a reflector) at the same angle as one another. Accordingly, extraction element 120 emits collimated light to the eye of a viewer.

In some embodiments, the gradient index of a light guide is present at all locations between the first curved surface 112 and the second curved surface 114 (shown in FIG. 4); however, it is possible to achieve the desired performance if the gradient index is present at all locations where light traverses the lightguide (i.e., from the location I where light is input into the lightguide by the light source 110 to the location of one or more extraction elements 120). In some embodiments, the gradient index is present between edge EE of the lightguide and the location of the one or more extraction elements 120.

Due to the angle conservation provided by lightguides according to aspects of the present invention, light source designs and image content suitable for use with planar lightguides are also suitable for use with curved light guides according to aspects of the present invention thus simplifying the design of display system. Preprocessing of images to be projected by a light source may be achieved by mapping a desired light output from the lightguide back though the display system to determine a suitable source arrangement (i.e., source location and structure).

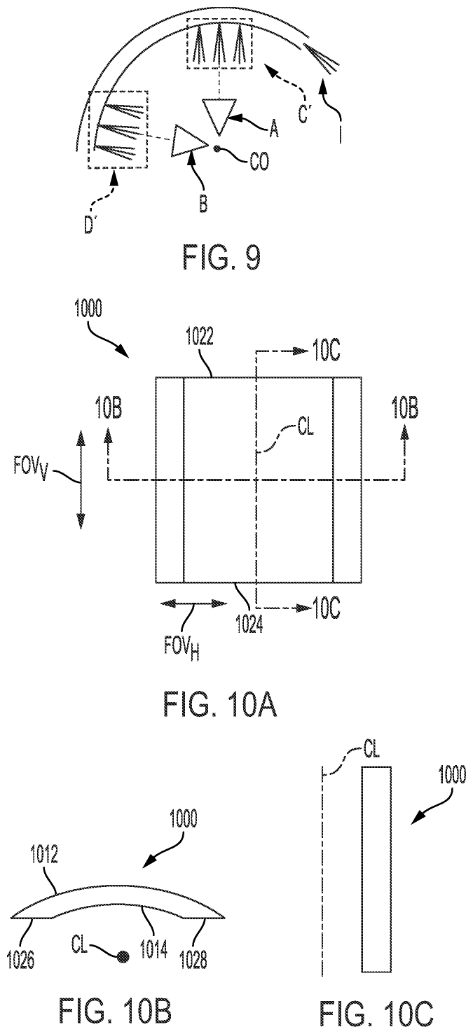

FIG. 9 is a schematic illustration of the performance of the display system 800 of FIG. 8 along a single plane including point I and the center point CO of the spherical gradient index. As illustrated, different eye positions A and B may accept rays of light from different location C′ and D′ in the field of view. As illustrated, rays at multiple angles are emitted from each of locations C′ and D′, the angles corresponding to different input angles. Light from locations in the field of view (e.g., C′ and D′) may be from a common extraction element or from two or more distinct extraction elements. A viewer's eye is located proximate the center point CO and that light exiting the lightguide surface is directed generally toward the center point CO (i.e., as is apparent from FIG. 9, light from the extraction elements is emitted with some variation and angle; however, the light is capturable by an eye located at point CO and rotating about point CO).

It will be appreciated that, although a lens having a spherical geometry (i.e., a spherical shell lens) is desirable for some applications due to its ability to more thoroughly conserve ray angles, a cylindrical shell lens may be more practical in some instances.

FIGS. 10A-10C are schematic illustrations of an example of a cylindrical shell light guide 1000 having a cylindrical gradient index according to aspects of the present invention. For a cylindrical shell lightguide, the outer surfaces 1012 and 1014 are concentric about a center line CL. For any cross-section through the cylindrical shell that is perpendicular to center line CL, there is a corresponding point (e.g. point CO) on the center line about which the outer surfaces of the lightguide are concentric; however, each point CO on the center line CL only has a single cross-section for which the outer surfaces are concentric about the point CO.

Because a cylindrical lightguide suitably preserves ray angles of rays in a plane perpendicular to center line CL in the gradient index of the lightguide, display systems having a cylindrical lightguide are typically used in applications where the field of view in a first dimension (e.g., FOV_{H}) is greater than the field of view in a second dimension (e.g., FOV_{V}) perpendicular the first dimension. In the dimension parallel to center line CL, the field of view is limited so ray angles are conserved well enough to allow images to be perceived by a viewer. Like a spherical shell lens, extraction elements, a light source and an image content suitable for use with a planar light guide may be used with a cylindrical lightguide.

In the illustrated embodiment, the cylindrical lightguide has a cylindrical gradient index that is symmetric about center line CL; however, acceptable performance may be achieved using a cylindrical lightguide having a spherical gradient index, where center point CO of the spherical gradient index is located along center line CL of the cylindrical lightguide. In some embodiments of cylindrical lightguides, it is advantageous that side(s) 1022, 1024, 1026 and/or 1028 are flat, which allows for simplified interfacing with a light source (not shown) to form a light input location.

Typically, lightguides as set forth above are used in display applications. Therefore, the typical design band is visible light, 400-700 nm wavelength. This design band need not be continuous and in some embodiments, a discrete design band may be more practical to reduce demand on diffraction grating design. A discrete wavelength band will also generally reduce power consumption. Although some embodiments of the present invention are intended for continuous or discontinuous visible spectra, other embodiments may produce images outside of the visible spectrum.

Although various embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. An optical apparatus for guiding and projecting light, comprising:
a lightguide comprised of a transmission medium having a first curved outer surface and a second curved outer surface and in at least one cross-section of the lightguide, the first curved outer surface and the second curved outer surface are substantially concentric around a point, the transmission medium having a gradient index that decreases as function of increasing distance from the point, the gradient index extending from the first curved surface to the second curved surface; and
at least one light extraction element disposed to extract light from the transmission medium and direct the light generally toward the point.

2. The apparatus of claim 1, wherein the apparatus further comprises a light source to project light into the lightguide.

3. The apparatus of claim 2, wherein the light source is configured and arranged to project light into an edge of the lightguide.

4. The apparatus of claim 2, wherein the light source is adapted to emit light within a visible band.

5. The apparatus of claim 4, wherein the light source is adapted to emit light at one or more discrete wavelengths within the visible band.

6. The apparatus of claim 1, wherein the gradient index decreases monotonically as function of increasing distance from the point.

7. The apparatus of claim 1, wherein the first curved outer surface and the second curved outer surface are spherical surfaces substantially concentric around the point, and the gradient index is a spherical gradient index having a center point at the point.

8. The apparatus of claim 7, wherein the apparatus further comprises a light source arranged to project light into the lightguide.

9. The apparatus of claim 8, wherein the light source is adapted to emit light within a visible band.

10. The apparatus of claim 8, wherein the light source is adapted to emit light at one or more discrete wavelengths within the visible band.

11. The apparatus of claim 1, wherein the gradient index is present at substantially all locations between the first curved surface and the second curved surface.

12. The apparatus of claim 1 wherein the first curved outer surface and the second curved outer surface are cylindrical surfaces substantially concentric around a center line, and the gradient index is a cylindrical gradient index symmetric around the center line, and wherein the point is located on the center line.

13. The apparatus of claim 12, wherein the apparatus further comprises a light source arranged to project light into the lightguide.

14. The apparatus of claim 12, wherein the lightguide has a flat side, and wherein the apparatus further comprises a light source arranged to project light into the lightguide through the flat side.

15. The apparatus of claim 12, wherein the light source is adapted to emit light within a visible band.

16. The apparatus of claim 15, wherein the light source is adapted to emit light at one or more discrete wavelengths within the visible band.

17. A curved lightguide, comprising:
a transmission medium having a first curved outer surface and a second curved outer surface and in at least one cross-section of the lightguide, the first curved outer surface and the second curved outer surface substantially concentric around a point, the transmission medium having a gradient index that decreases as function of increasing distance from the point, the gradient index extending from the first curved surface to the second curved surface.

18. The apparatus of claim 17, wherein the first curved outer surface and the second curved outer surface are spherical surfaces substantially concentric around the point, and the gradient index is a spherical gradient index having a center point at the point.

19. The apparatus of claim 17, wherein the first curved outer surface and the second curved outer surface are cylindrical surfaces substantially concentric around a center line, and the gradient index is a cylindrical gradient index symmetric around the center line, and wherein the point is located on the center line.
